(19) United States
(12) Patent Application Publication
(10) Pub. No.: US 2017/0350105 A1
(43) Pub. Date: Dec. 7, 2017

(54) ELECTRONIC FAUCET

(71) Applicant: MAAX BATH INC., Lachine (CA)

(72) Inventors: Charles Kerwin BRADDOCK, Ellicott City, MD (US); Thomas Stuart DEBAUGH, Mount Airy, MD (US)

(73) Assignee: MAAX BATH INC., Lachine (CA)

(21) Appl. No.: 15/611,863

(22) Filed: Jun. 2, 2017

Related U.S. Application Data
(60) Provisional application No. 62/345,508, filed on Jun. 3, 2016.

(51) Int. Cl. E03C 1/05; E03C 1/04; F16K 31/02; E03C 1/02; F16K 31/00

(52) U.S. Cl. CPC E03C 1/055; F16K 31/02; E03C 1/02; E03C 1/0404; F16K 31/00

(57) ABSTRACT

An automated liquid delivery system comprising: a housing defining an internal chamber, the housing comprising at least one delivery hole; a flow control valve inserted into the internal chamber and connectable to a source of liquid, the flow control valve for controlling a flow of liquid coming from the source of liquid; at least one pipe inserted into the internal chamber and connected to the flow control valve for delivering the liquid coming from the flow control valve through the delivery hole of the housing; a controller inserted into the internal chamber for controlling the flow control valve, the flow control valve and the controller being powerable by a battery insertable into the housing; and a cover securable to the housing for enclosing the flow control valve, the pipe, the controller and the battery therein.

### TECHNICAL FIELD

The present invention relates to the field of faucets, and more particularly to electronic faucets.

### BACKGROUND

In order to provide an automated water delivery system to a container such as an automated bathtub or shower, an electronic faucet or shower head is required. Such an automated water delivery system may be remotely controlled to remotely control the flow of water. Therefore, electrical power must be provided to the automated water delivery system. Connecting the automated water delivery system to the power grid may require construction work such as removing the bathtub or making holes in a wall to electrically connect the automated water delivery system to the power grid, which is time-consuming and expensive.

Therefore, there is a need for an improved automated liquid delivery system.

### SUMMARY

According to a broad aspect, there is provided an automated liquid delivery system comprising: a housing defining an internal chamber, the housing comprising at least one delivery hole; a flow control valve inserted into the internal chamber and connectable to a source of liquid, the flow control valve for controlling a flow of liquid coming from the source of liquid; at least one pipe inserted into the internal chamber and connected to the flow control valve for delivering the liquid coming from the flow control valve through the delivery hole of the housing; a controller inserted into the internal chamber for controlling the flow control valve, the flow control valve and the controller being powerable by a battery insertable into the housing; and a cover securable to the housing for enclosing the flow control valve, the pipe, the controller and the battery therein.

In one embodiment, the automated liquid delivery system further comprises the battery.

In one embodiment, the battery comprises a rechargeable battery.

In one embodiment, the automated liquid delivery system further comprises a solar panel for charging the rechargeable battery.

In one embodiment, the solar panel is secured to the cover.

In one embodiment, the automated liquid delivery system further comprises a communication unit inserted into the internal chamber for at least receiving activation commands.

In one embodiment, the communication unit comprises a wireless communication unit.

In one embodiment, the automated liquid delivery system further comprises an activation key for activating the flow control valve.

In one embodiment, the activation key comprises one of a press button and a motion sensor.

In one embodiment, the automated liquid delivery system further comprises a temperature sensor inserted into the internal chamber for monitoring a temperature of the liquid to be delivered by the pipe.

In one embodiment, the temperature sensor comprises a thermistor secured to an outer surface of the pipe.

In one embodiment, the temperature sensor is inserted into the flow control valve.

In one embodiment, the automated liquid delivery system further comprises a flow meter for monitoring a flow rate of the liquid.

In one embodiment, the control flow valve comprises a mixing valve fluidly connectable to two sources of liquid.

In one embodiment, the automated liquid delivery system further comprises a level sensor for monitoring a level of liquid in a container in which the automated liquid delivery system is to deliver the liquid.

In one embodiment, the level sensor comprises an ultrasonic level sensor.

In one embodiment, the automated liquid delivery system further comprises a contactless temperature sensor for monitoring a temperature of the liquid when contained in a container in which the automated liquid delivery system is to deliver the liquid.

In one embodiment, the contactless temperature sensor comprises an infrared temperature sensor.

In one embodiment, the housing comprises a faucet housing, the automated liquid delivery system corresponding to an electronic faucet.

In another embodiment, the housing comprises a shower head housing, the automated liquid delivery system corresponding to an electronic shower head.

In another embodiment, the housing comprises a shower head housing, the automated liquid delivery system corresponding to an electronic shower head.

### BRIEF DESCRIPTION OF THE DRAWINGS

Further features and advantages of the present invention will become apparent from the following detailed description, taken in combination with the appended drawings, in which:

FIG. 1 is a perspective view of an electronic faucet comprising a cover, in accordance with a first embodiment;

FIG. 2 is a perspective view of the electronic faucet of FIG. 1 with the cover omitted, in accordance with an embodiment;

FIG. 3 is an exploded view of the electronic faucet of FIG. 1, in accordance with an embodiment;

FIG. 4 is a perspective view of an electronic faucet provided with a level sensor and a contactless temperature sensor, in accordance with a second embodiment;

FIG. 5 is a block diagram illustrating a controller for an electronic faucet, in accordance with an embodiment;

FIG. 6 illustrates a cover for an electronic faucet provided with a solar panel, in accordance with an embodiment.

It will be noted that throughout the appended drawings, like features are identified by like reference numerals.

### DETAILED DESCRIPTION

Referring to FIGS. 1 to 3, there is illustrated an electronic faucet 10 that may be used in connection with a bathtub, a sink, or the like. The electronic faucet 10 comprises a housing 12 defining an internal chamber 14 and a cover 16 that is removably securable to the housing 12. The housing 12 and the cover 16 are shaped so that the housing with the cover secured thereto has the shape of a faucet.

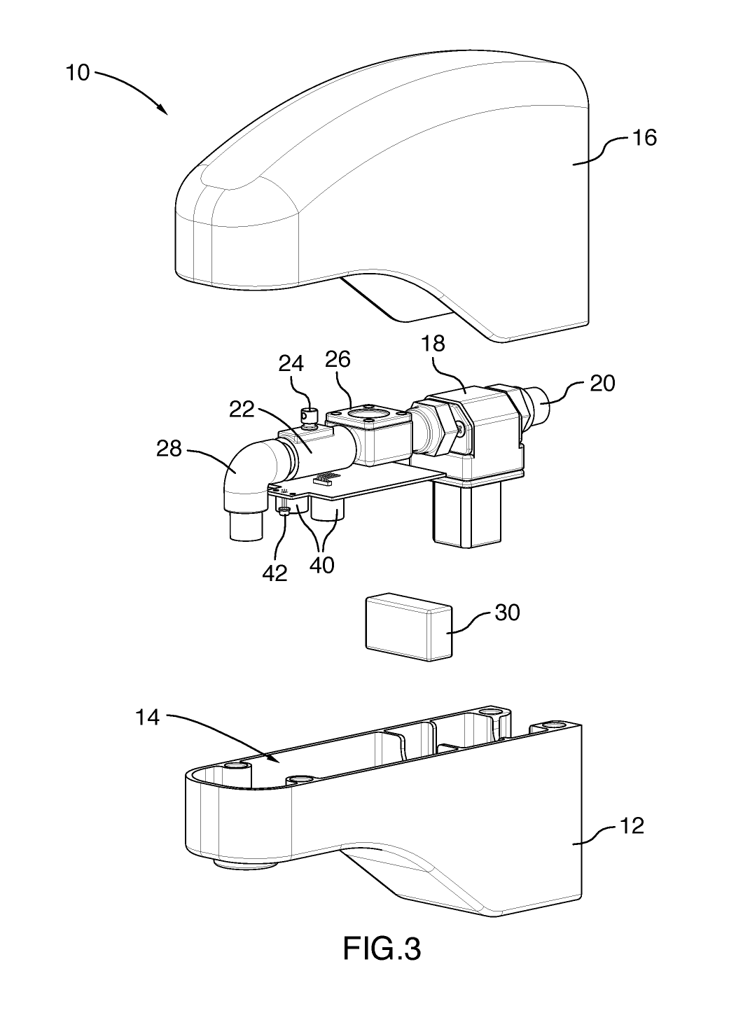

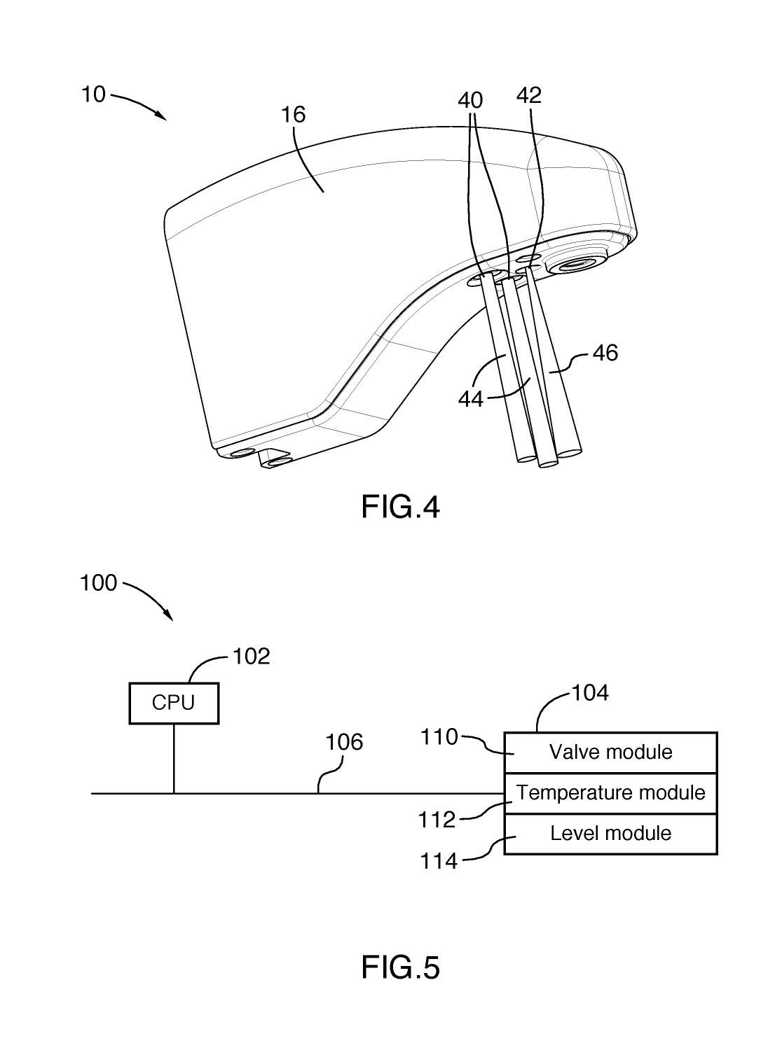

The electronic faucet 10 further comprises a flow control valve for receiving water from a source of water and controlling the flow of water to be delivered by the electronic faucet. The input of the flow control valve 18 is fluidly connected to a first pipe 20 in which water flows from the source of water. The output of the flow control valve 18 is fluidly connected to the input of a second pipe 22. A temperature sensor 24 such as a thermistor is secured to the outer surface of the pipe 22 in order to measure the temperature of the water flowing into the pipe 22. The output of the second pipe 22 is fluidly connected to the input of a flow meter 26 that is adapted to monitor the flow of the water flowing therethrough. The output of the flow meter 26 is fluidly connected to a water delivery pipe 28 which may have a curved shape as illustrated in FIG. 3. The water is delivered via the output of the pipe 28. It should be understood that the housing 12 comprises a water delivery hole on its bottom face to allow the water delivered by the pipe 28 to fall into the bathtub. In one embodiment, the output of the pipe 28 is inserted into the water delivery hole.

The electronic faucet 10 further comprises a battery 30 and a controller (not shown). The battery 30 is used for powering at least the controller and the flow control valve 18. The battery may also be used for powering other components such as temperature sensors, flow rate sensors, etc.

In one embodiment, the battery 30 is a rechargeable battery.

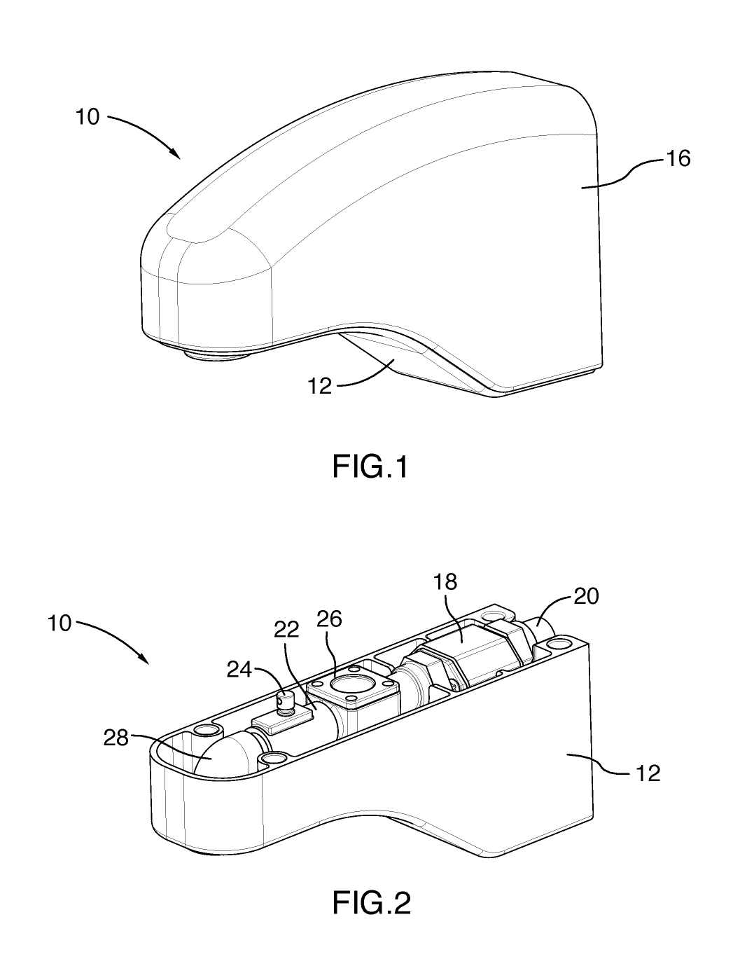

As illustrated in FIG. 2, the internal chamber 14 may extend from the top of the housing 12 and the cover 16 is then securable on the top of the housing 12 as illustrated in FIG. 1. The flow control valve 18, the second pipe 22, the temperature sensor 24, the flow meter 26, the pipe 28, and the battery 30 are received within the internal chamber 14 of the housing 12.

In one embodiment, the flow control valve 18 is directly connected to a single source of water. In this case, the temperature sensor 24 may be omitted.

In another embodiment, the flow control valve 18 is fluidly connected to a mixing valve that is fluidly connected to a source of hot water and a source of cold water. The controller may be adapted to control the operation of the mixing valve in order to control the temperature of the water to be delivered by the electronic faucet 10.

In a further embodiment, the flow control valve 18 may be a mixing valve fluidly connected to both a source of hot water and a source of cold water. In this case, the controller is adapted to control the flow control valve 18 to adjust the flow of hot water and the flow of cold water flowing therethrough and adjust the temperature of the water delivered by the electronic faucet 10.

In one embodiment, the electronic faucet 10 further comprises a communication unit such as a wireless communication unit for receiving commands for the activation of the electronic faucet. For example, the electronic faucet 10 may be remotely controlled by a user using a remote control such as a mobile device. In this case, when the user inputs a command for opening the electronic faucet 10, the remote control sends a command indicative of the opening for the electronic faucet to the electronic faucet 10. The controller of the electronic faucet 10 receives the command via the communication unit and opens the flow control valve according to the received command to deliver water. Similarly, when the user inputs a command for closing the electronic faucet 10, the remote control sends a command indicative of the closing for the electronic faucet to the electronic faucet 10. The controller of the electronic faucet 10 receives the command via the communication unit and closes the flow control valve according to the received command to deliver water.

In an embodiment in which the electronic faucet 10 comprises a temperature sensor 24, the controller may be adapted to receive the measured temperature of the water flowing into the pipe 22 from the temperature sensor 24 and transmit the measured temperature via the communication unit.

In an embodiment in which the electronic faucet comprises a flow meter 26, the controller may be adapted to receive the flow of the water measured by the flow meter 26 and transmit the measured flow via the communication unit.

In an embodiment in which the electronic faucet 10 comprises a temperature sensor 24, the controller may be adapted to receive from a remote control a desired temperature for the water to be delivered via the communication unit. In this case, the controller may be adapted to adjust the flows of hot and cold water by controlling the mixing valve so that the temperature measured by the temperature sensor 24 substantially corresponds to the temperature desired by the user.

In one embodiment, the electronic faucet 10 comprises no temperature sensor 24 and the controller comprises a database containing mixing valve setting conditions for different water temperatures. In this case, upon receiving a desired temperature for the water, the controller retrieves from the database the mixing valve setting conditions that correspond to the received desired temperature and applies the retrieved mixing valve setting conditions to the mixing valve in order to obtain water having the desired temperature.

In another embodiment in which the faucet 10 is provided with the temperature sensor 24, the controller may apply a feedback loop control method to obtain the desired temperature. In this case, the controller receives the temperature measured by the temperature sensor 24 and adjusts the mixing valve setting conditions until the desired temperature is obtained.

In the same or another embodiment in which the electronic faucet 10 comprises a flow meter for measuring water flow rates, the controller may be adapted to receive from a remote control a desired flow for the water to be delivered via the communication unit. In this case, the controller may be adapted to adjust the flow of water by controlling the control flow valve 18 so that the flow measured by the temperature sensor 24 substantially corresponds to the received desired flow.

In another embodiment, the electronic faucet 10 may be provided with an activation device for opening and closing the faucet 10. For example, the electronic faucet may be provided with an activation key such as a press button for opening and closing the electronic faucet. In another example, the activation device may be a motion sensor.

In one embodiment, the electronic faucet 10 further comprises a level senor such as a contactless level senor for measuring the level of water in the container with which the electronic faucet 10 is used. For example, the electronic faucet 10 may comprise a dual ultrasonic sensor 40 adapted to measure the distance between the water within the bathtub and the sensor 40. The dual ultrasonic sensor 40 is adapted to emit two ultrasound wave beams 44 which reflected by the surface of the liquid, e.g. water, and to detect the reflected ultrasound wave beams to measure the distance between the surface of the liquid and the dual ultrasonic sensor 40. The controller may then determine the level of liquid within the container or the volume of liquid in the container using from the measured distance between the surface of the liquid and the dual ultrasonic sensor 40.

In one embodiment the controller is adapted to receive a command indicative of a desired level of water within the bathtub. In this case, the controller is adapted to receive the measured level of water from the level sensor 40 close the control flow valve 18 when it determines that the measured level substantially corresponds to the desired level.

In the same or another embodiment, the electronic faucet further comprises a contact less temperature sensor 42 for remotely measuring the temperature of the liquid contained in the container. For example, the contactless temperature sensor may be an infrared temperature sensor 42. The infrared temperature sensor 42 is adapted to emit a beam 46 of infrared light which is reflected by the surface of the liquid contained in the container, and to detect the reflected light beam to measure the temperature of the liquid.

In one embodiment, the controller is adapted to receive a command indicative of a desired temperature for the water in the bathtub and the measured temperature from the contactless temperature sensor 42. The controller then compares the measured temperature to the desired temperature and controls the mixing valve to add water having an adequate temperature until the measured temperature substantially corresponds to the desired temperature. If the measured temperature is less than the desired temperature, the controller is adapted to control the mixing valve so as to add hot water. If the measured temperature is greater than the desired temperature, the controller is adapted to control the mixing valve so as to add cold water.

It should be understood that the contactless level sensor 40 and the contactless temperature sensor 42 may be positioned at any adequate location on the housing 12 of the electronic faucet 10 as long as they can sense the water contained in the bathtub. In the illustrated embodiment the housing comprises holes on its wall that faces the bottom of the bathtub once installed, adjacent to the output of the pipe 28. As a result, the contactless level sensor 40 and the contactless temperature sensor 42 face the bottom of the bathtub.

FIG. 5 is a block diagram illustrating an exemplary controller contained in the electronic faucet 10, in accordance with some embodiments. The processing module 100 typically includes one or more Computer Processing Units (CPUs) or Graphic Processing Units (GPUs) 102 for executing modules or programs and/or instructions stored in memory 104 and thereby performing processing operations, memory 104, and one or more communication buses 106 for interconnecting these components. The communication buses 106 optionally include circuitry (sometimes called a chipset) that interconnects and controls communications between system components. The memory 104 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 104 optionally includes one or more storage devices remotely located from the CPU(s) 102. The memory 104, or alternately the non-volatile memory device(s) within the memory 104, comprises a non-transitory computer readable storage medium. In some embodiments, the memory 104, or the computer readable storage medium of the memory 104 stores the following programs, modules, and data structures, or a subset thereof:
a valve module 110 for controlling the operation of the control flow valve and/or the mixing valve;
a level module 112 for determining if a desired level has been reached; and
a temperature module 114 for determining if a desired temperature has been reached.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise rearranged in various embodiments. In some embodiments, the memory 104 may store a subset of the modules and data structures identified above. Furthermore, the memory 104 may store additional modules and data structures not described above.

Although FIG. 5 shows a processing module 100, FIG. 3 is intended more as functional description of the various features which may be present in a management module than as a structural schematic of the embodiments described herein. In practice, and as recognized by those of ordinary skill in the art, items shown separately could be combined and some items could be separated.

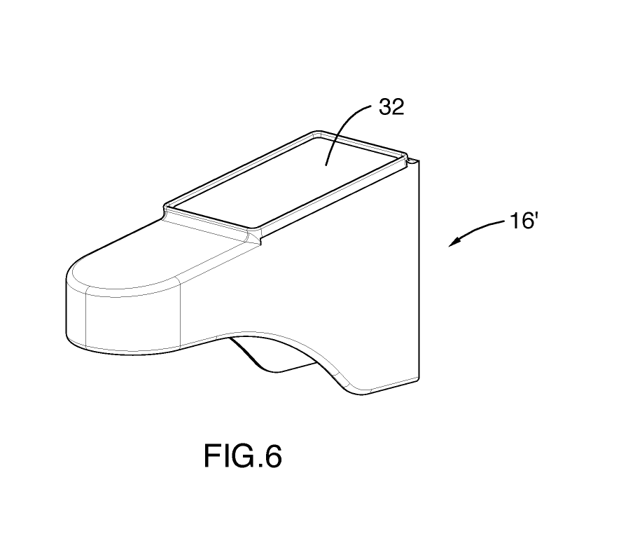

FIG. 6 illustrates an alternate cover 16′ which may be used when the battery 30 is a rechargeable battery. The cover 16′ is provided with a solar panel 32 comprising photovoltaic cells for charging the rechargeable battery. The solar panel 32 is electrically connected to the battery 30 via a permanent electrical connection or a disconnectable electrical connector. It should be understood that the solar panel 32 may be secured at any adequate position on the housing 12 or the cover 16′. For example, the solar panel 32 may be secured on the top face of the cover 16′ as illustrated in FIG. 6.

While in the present description there is described an electronic faucet, it should be understood that the housing and the cover may be chosen so that the present system applies to any adequate type of automated liquid delivery systems. For example, the automated liquid delivery system may be shower head. In this case, the housing is shaped and sized to correspond to a shower head housing and the cover is chosen so as to correspond to a shower head cover.

The embodiments of the invention described above are intended to be exemplary only. The scope of the invention is therefore intended to be limited solely by the scope of the appended claims.

I/We claim:

1. An automated liquid delivery system comprising:
a housing defining an internal chamber, the housing comprising at least one delivery hole;
a flow control valve inserted into the internal chamber and connectable to a source of liquid, the flow control valve for controlling a flow of liquid coming from the source of liquid;
at least one pipe inserted into the internal chamber and connected to the flow control valve for delivering the liquid coming from the flow control valve through the delivery hole of the housing;
a controller inserted into the internal chamber for controlling the flow control valve, the flow control valve and the controller being powerable by a battery insertable into the housing; and
a cover securable to the housing for enclosing the flow control valve, the pipe, the controller and the battery therein.

2. The automated liquid delivery system of claim 1, further comprising the battery.

3. The automated liquid delivery system of claim 2, wherein the battery comprises a rechargeable battery.

4. The automated liquid delivery system of claim 3, further comprising a solar panel for charging the rechargeable battery.

5. The automated liquid delivery system of claim 4, wherein the solar panel is secured to the cover.

6. The automated liquid delivery system of claim 1, further comprising a communication unit inserted into the internal chamber for at least receiving activation commands.

7. The automated liquid delivery system of claim 6, wherein the communication unit comprises a wireless communication unit.

8. The automated liquid delivery system of claim 1, further comprising an activation key for activating the flow control valve.

9. The automated liquid delivery system of claim 8, wherein the activation key comprises one of a press button and a motion sensor.

10. The automated liquid delivery system of claim 1, further comprising a temperature sensor inserted into the internal chamber for monitoring a temperature of the liquid to be delivered by the pipe.

11. The automated liquid delivery system of claim 10, wherein the temperature sensor comprises a thermistor secured to an outer surface of the pipe.

12. The automated liquid delivery system of claim 10, wherein the temperature sensor is inserted into the flow control valve.

13. The automated liquid delivery system of claim 1, further comprising a flow meter for monitoring a flow rate of the liquid.

14. The automated liquid delivery system of claim 1, wherein the control flow valve comprises a mixing valve fluidly connectable to two sources of liquid.

15. The automated liquid delivery system of claim 1, further comprising a level sensor for monitoring a level of liquid in a container in which the automated liquid delivery system is to deliver the liquid.

16. The automated liquid delivery system of claim 15, wherein the level sensor comprises an ultrasonic level sensor.

17. The automated liquid delivery system of claim 1, further comprising a contactless temperature sensor for monitoring a temperature of the liquid when contained in a container in which the automated liquid delivery system is to deliver the liquid.

18. The automated liquid delivery system of claim 17, wherein the contactless temperature sensor comprises an infrared temperature sensor.

19. The automated liquid delivery system of claim 1, wherein the housing comprises a faucet housing, the automated liquid delivery system corresponding to an electronic faucet.

20. The automated liquid delivery system of claim 1, wherein the housing comprises a shower head housing, the automated liquid delivery system corresponding to an electronic shower head.
